(19) United States
(12) Patent Application Publication
(10) Pub. No.: US 2026/0030660 A1
(43) Pub. Date: Jan. 29, 2026

(54) System and method of regulating and compounding of financial and commercial products and services through a reciprocating crowdgifting (RCG) system

(71) Applicant: ANTHONY ST MICHAEL, Milford, OH (US)

(72) Inventor: ANTHONY ST MICHAEL, Milford, OH (US)

(21) Appl. No.: 18/784,981

(22) Filed: Jul. 26, 2024

(51) Int. Cl. G06Q 30/0279; G06Q 20/06; G06Q 40/10

(52) U.S. Cl. CPC G06Q 30/0279; G06Q 20/065; G06Q 40/10

(57) ABSTRACT

The present invention relates to a method of regulating and compounding of financial services in a reciprocating crowdgifting (RCG) system. The method includes collecting a predefined amount of gifts from new participants of the RCG system. The RCG system is managed by a reciprocating crowdgifting (RCG) module (106). The method further includes generating a compounding effect of the financial services by providing provisions for re-entry of the existing participants in the RCG system. Further, the method includes providing provisions to avail the financial services on the basis of contributed gift(s) by the participant. The financial services are availed through either fiat currency or inter-system cryptocurrency. The method further includes duplicating the financial services in a parallel RCG charitable account to reduce the tax liability of the participants.

### CROSSREFERENCE AND CONTINUATION IN PART TO RELATED APPLICATION

The present non-provisional patent application is a Continuation-In-Part of U.S. non-Provisional Utility application Ser. No. 17/978,946, filed on Nov. 1, 2022, the disclosure all of which is incorporated by reference in its entities.

### TECHNICAL FIELD

This invention relates to an intercorrelated Finance and Commerce system. Specifically, the present invention relates to a system and method of regulating and compounding of monetary and commercial products and services through a Reciprocating crowdgifting (RCG) system.

### BACKGROUND OF THE INVENTION

It can be said that humanity is its own greatest resource, and the technologies that have been developed have greatly enhanced and elevated the lifestyles of much of mankind. However, the vast majority of humanity nevertheless continues to labor under monetary want and deprivation, notwithstanding all of the modern technologies meant to supply mankind with sufficient to abundant money, goods, and services.

For the average person faced with erratic economic conditions, declining wages, inflation, reduced or non-existent retirements, underfunded to failing government benefit programs, ever rising costs and insurance rates, insufficient education, mental or physical health issues, and a host of other inhibiting factors, monetary generation or acquisition is the number one need and concern. The system disclosed seeks to lessen or near entirely resolve these problems.

One aspect of the technology concerned herein is money, products and services generation through modified crowdgifting and residual income type systems such as multilevel or direct marketing. One purpose is to provide the populous at large with a fully passive income type system, coincidentally comprised of finance products, commerce, goods and services. Other purposes include, but are not limited to, supporting governments along with stimulating businesses and economies.

Crowdgifting and passive or residual income type systems are typically well known and generally accessible to the vast majority of humankind. However, the utilization of these income systems for the monetary benefit of the vast majority of humankind has been lacking in efficacy for any number of reasons, not the least of which concerns the lack of start-up money, personal technical prowess, or any varied requisite ability, along with the shortcomings of the systems themselves producing exceptionally high failure rate outcomes most of the time for most of the people.

The ability of people to earn or generate money, therefore, becomes societally lopsided, leaving the average person, the elderly, the disabled, without the talent, education, or any varied means to easily and readily earn or generate money utilizing crowdgifting or residual income type systems. These varying debilities extend to even ordinary employment means of individuals generating sufficient money to adequately support themselves and their families in the near-term, or moreover, for individuals to provide for their future and retirement needs.

A need, therefore, exists to provide for a crowdgifting type donation or gifting system which works all of the time for all of the participants involved, as well as a Social Network Marketing system which does not require the participants to unreasonably self-educate, other-educate, sell any product, or recruit others. Further, a need exists to provide for a passive and residual type income readily and easily available to the average person, the young, the elderly, the disabled, the under-educated.

Furthermore, traditional peer-to-peer equity, gifting, and rewards crowdgifting, as a well known and legal means of pursuing the generation and sharing of wealth suffer varied shortcomings and resulting failures. A need therefore exists to correct these deficiencies. To this end, the present invention utilizes an entirely novel and hybrid approach in employing certain qualities of the various crowdgifting systems within one System to partially or entirely overcome those shortcomings and failures.

Whereas, in large measure the Property/Casualty insurance industry is effectively a legalized Ponzi scheme, proven by myriad Property/Casualty Insurance industry insolvencies, modern insurance systems are engineered in such a way that they can fail and create financial and associated crisis such as the “Too Big to Fail” financial meltdown of 2008. A need therefore exists for a more stable form of personal Property/Casualty insurance and fail-safe systematic approach to insurance in general. The present invention seeks to alternately provide a more robust insurance system approach, or a support mechanism for, or a safety mechanism against, such potentially volatile and increasingly frail modern insurance systems. This approach can effectively provide a more achievable, expansive, and comprehensive insurance landscape.

Loans can be difficult to come by, and qualifying for them can be prohibitive for those with a medium to low credit score. This, along with inflation and high-interest rates can prohibit the purchase of cars and homes and even lesser modern necessities which are the mainstay of life. Furthermore, insurance companies can, and often do, deny applicants based on a poor credit score. Even employability can be compromised when employers judge employees by their credit standing. Therefore, the savings and loan area of finance is crucial to the livelihood and well-being of individuals and families. The system disclosed seeks to generally resolve credit unworthiness related problems.

Government assistance programs are dependent upon a strong economy and a strong consequent tax base. Government retirement programs are equally and likewise dependent. Corporations and businesses rely on the strength of economic activity to generate sufficient revenue to provide their employees with sufficient wages, retirements, and healthcare. Therefore, economic systems are key to the health of individuals, societies, their governing bodies, and businesses. The system disclosed seeks to support, supplement, or replace varied government and corporate benefit systems.

Monetary policies of governments, banking, lending, and financial institutions, along with monetary systems including fiat currencies, cryptocurrencies, DeFi, stock and bond markets, and financial and monetary instruments in general are systems largely outside the deeper or operative understanding of the average person, but within their general knowledge. These systems operate often to the exclusion of the vast masses if not their detriment, generally benefiting and enriching only those who are keenly adept at them. The greater masses of humanity therefore are unable to utilize these systems to readily generate wealth for themselves. Additionally, these systems tend to be complex, manipulated, exclusive, and sometimes unreliable, resulting in uncertainty and subsequently unusable for even the above-average person to benefit from them, and certainly not without any significant background, education or effort. The system disclosed seeks to partially or entirely resolve this problem.

Due to the inescapable and incurable value volatility and price manipulation of mainstream cryptocurrencies, along with the proven insecurity and instability of Stable Coin and other Decentralized Finance (DeFi), these effectively non-currency currencies, largely limited to, and employed principally in the Banking, Finance, and FinTech sectors, and being primarily and purely a means of currency conversion, storage, and transfer, in their present state can never be effectively utilized in broad commerce and services sectors by and among the general populous. A need therefore exists, which the present invention seeks to resolve, many, if not most of the typical problems associated with mainstream cryptocurrency, tokens, and other DeFi blockchain type monetary instruments, by utilizing a dual internal and external monetary system methodology associated with the (Eco) System and its methodologies described, to provide for an underwritten and commercially stable and viable usage of those instruments among businesses (B2B) and the populous (P2P).

Additionally, a need also exists to provide a more stable, globally and societally beneficial economic system; a useful and workable Universal Basic Income (UBI) or combined monetary, finance, commerce, services, and economic system that can effectively generate, re-generate, distribute, re-distribute, and compound, money, goods, and services, easily and attainably by, and to the benefit of, the vast masses of humanity, from the young to the elderly, the uneducated, and the disabled, from cradle to grave; a system which additionally supports businesses and governments, and stimulates world economies; a system which can be superimposed upon existing world and existing technology systems wholistically and organically.

### SUMMARY OF THE INVENTION

In one embodiment, the present invention provides a method of regulating and compounding of money, products, or services, through a Reciprocating Crowdgifting (RCG) system. The method includes collecting a predefined amount of gift from new participant of the RCG system. The RCG system is managed by one or more reciprocating crowdgifting (RCG) modules. Modules can be defined as: “A standardized part or independent unit that can be used to construct a more complex structure when duplicated and combined to perform synchronously.” Further, the method includes generating a compounding effect of the money, products, or services, by provisioning for re-entry of the existing participants in the RCG system. The method further includes provisioning to avail the money, products, or services, on the basis of contributed gift donation(s) by the participant. The money, products, or services are represented by and availed through an inter-system cryptocurrency and/or smart contract. Furthermore, the method includes duplicating the RCG module to perform as a “parallel gifting” charitable account to reduce the tax liability of the participants when used in conjunction with a primary money, products, or services RCG module. Additionally, using an RCG module singularly as a charitable gifting service can reduce taxes of income received outside of the RCG system.

In one aspect, the collected gift from the new participant is transferred to a participant upline in the RCG system.

In another aspect, the RCG module is configured to create a self-perpetuating crowdgifting system.

In another aspect, the RCG module is configured comprising a binary, or trinary, or unilevel, or matrixed methodology for the calculation, distribution, and redistribution of money, products, or services.

In another aspect, the method further includes compounding the gift by re-entering the binary, trinary, unilevel, or matrixed crowdgifting system within the RCG system.

In another aspect, the method further includes compounding the gift by manual or auto-entry and advancement into a single or number of subsequent RCG modules positioned in successive stages.

In another aspect, the financial, and commercial services are based on blockchain technology.

In another aspect, the financial and commercial services are comprised of coupons, cash, loan, products, and services.

In another aspect, the method further includes the RCG system performing within an RCG system as a series of crowdgifting systems within the RCG system or within a series of the RCG systems.

In another aspect, the method includes utilizing a dual inter-system and ecto-system Cryptocurrency, Token, or other such DeFi mechanism to secure and stabilize the inter-system cryptocurrency.

In another aspect, the dual inter-system and ecto-system Cryptocurrency, Token, or other such DeFi, are comprised of utilizing the RCG system matrix methodology, separately, or concomitantly, or circuitously.

In another aspect, the method includes distributing financial services comprising a Matrix within a Matrix or series of Matrixes within the RCG system. The matrix is a binary, trinary, unilevel, or other form of matrix of participants mapped to an existing participant.

In another aspect, the method includes capitalizing or underwriting the distributed financial services to a financial organization to secure loans, Property or Medical Insurance by the participants.

In another aspect, the method includes generating a code or other method to connect the RCG system to the parallel RCG chartable account. Further, the method includes duplicating the financial services of the RCG system to the chartable account through such means as a computerized database.

### BRIEF DESCRIPTION OF THE INVENTION

Various objects, features, aspects and advantages of the inventive subject matter will become more apparent from the following detailed description of preferred embodiments, along with the accompanying drawing figures in which like numerals represent like components.

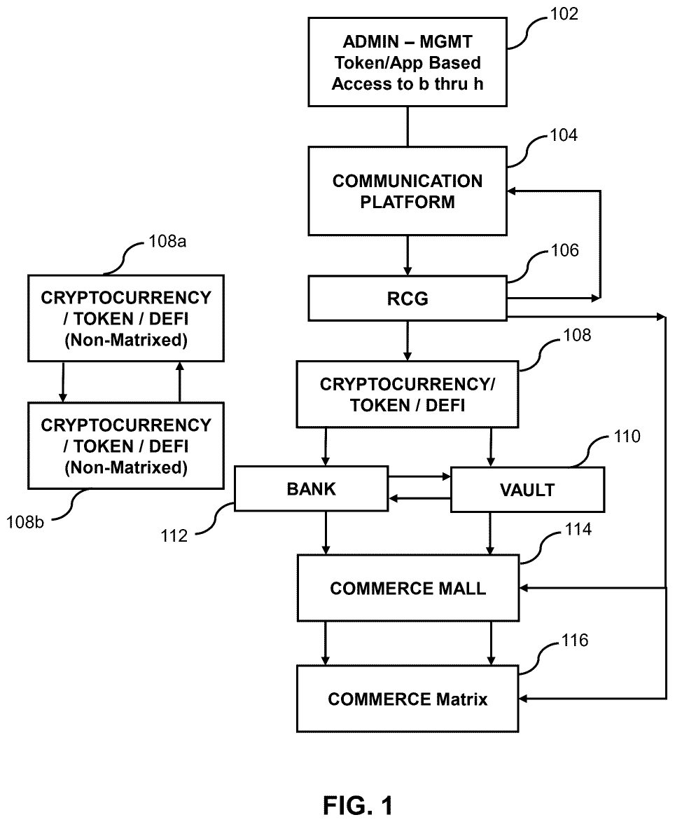

FIG. 1 illustrates a block diagram of a system of regulating and compounding of financial services in a Reciprocating crowdgifting (RCG) system, according to an embodiment of the present disclosure.

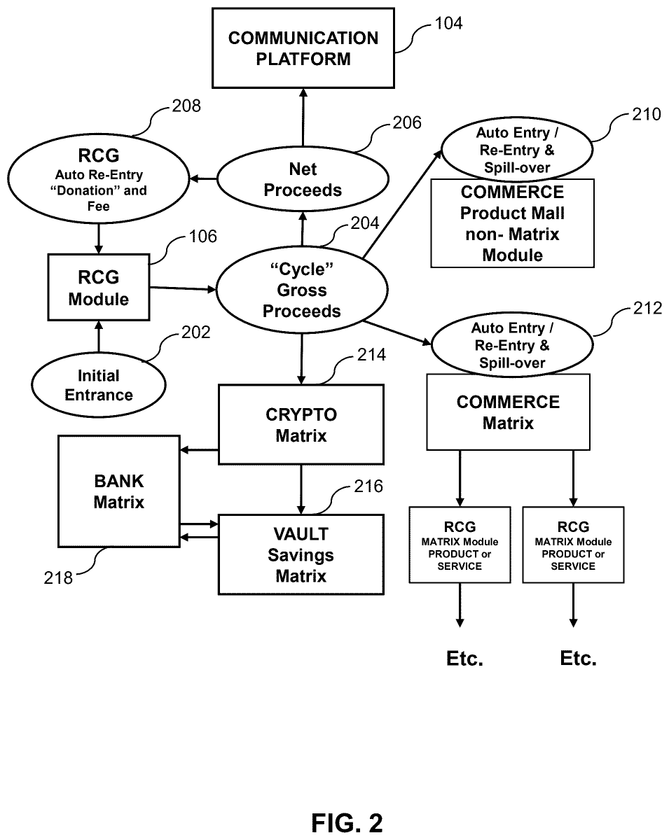

FIG. 2 illustrates a flowchart of a process of regulating and compounding of financial services in a crowdgifting system, according to an embodiment of the present disclosure.

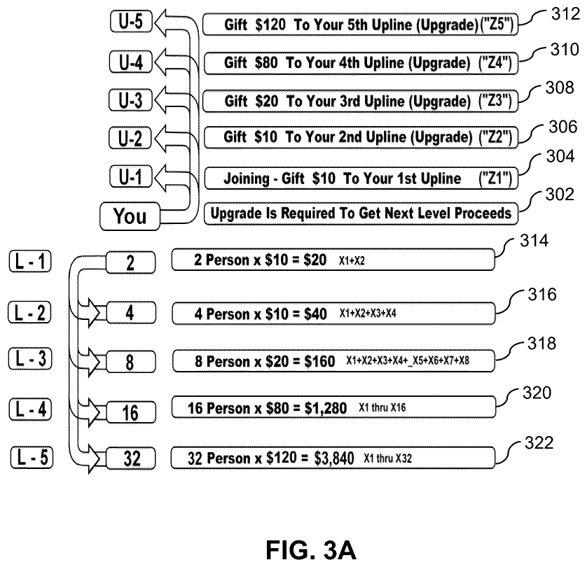

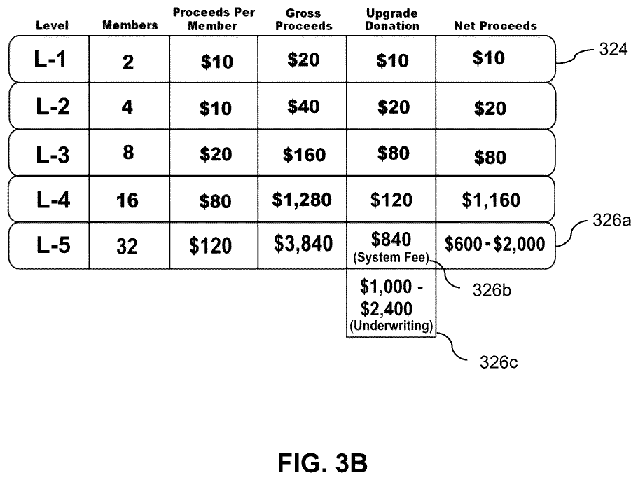

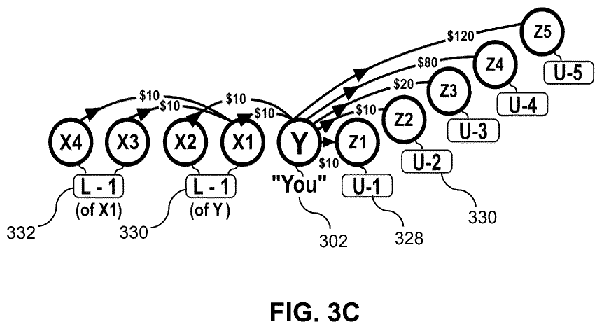

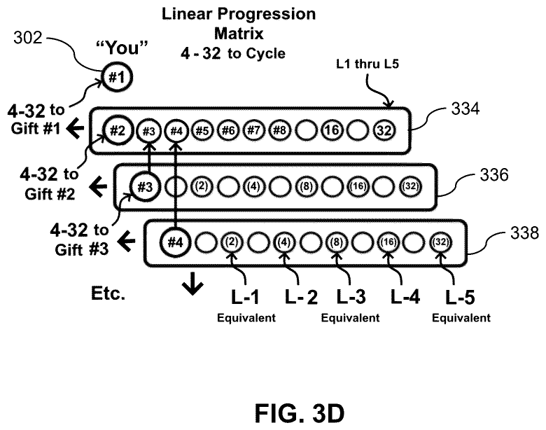

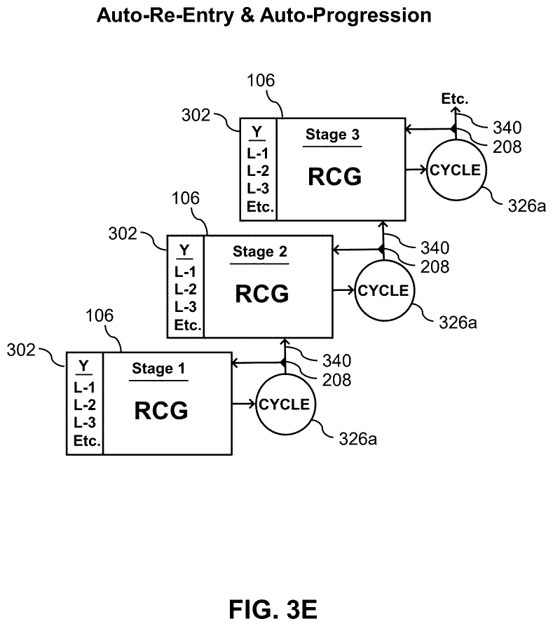

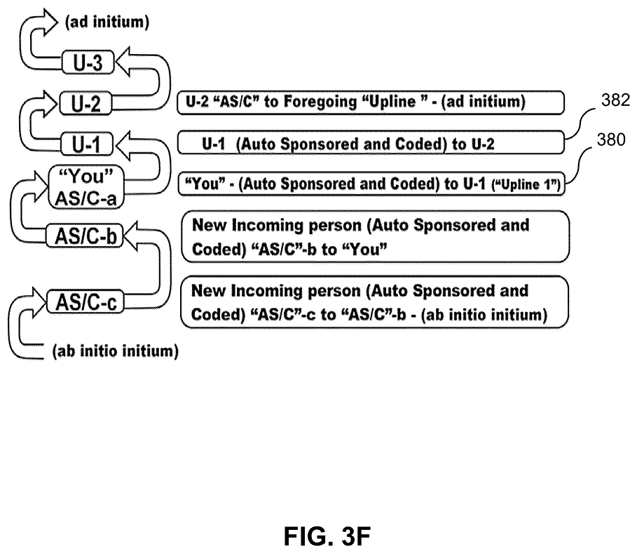

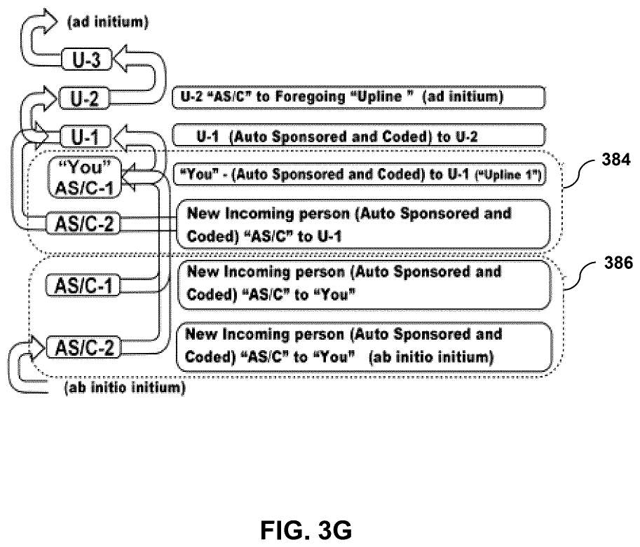

FIG. 3A illustrates a hybrid binary-matrix flow diagram of distribution of gifts using a reciprocating crowdgifting (RCG) module, according to an embodiment of the present disclosure.

FIG. 3B illustrates a hybrid binary-matrix flow diagram of distribution of gifts using a reciprocating crowdgifting (RCG) module, according to an embodiment of the present disclosure.

FIG. 3C illustrates a linear version of a hybrid binary-matrix flow diagram of distribution of gifts using a reciprocating crowdgifting (RCG) module, according to an embodiment of the present disclosure.

FIG. 3D illustrates a tubular hybrid binary-matrix version of a flow diagram of distribution of gifts using a reciprocating crowdgifting (RCG) module, according to an embodiment of the present disclosure.

FIG. 3E illustrates a hybrid binary-matrix with stages-progression flow diagram of distribution of gifts using a reciprocating crowdgifting (RCG) module, according to an embodiment of the present disclosure.

FIG. 3F illustrates an exemplary method of steps for compounding of gift donations of the crowdgifting system participants arranged in a linear, binary, or matrixed tree arrangement, according to an embodiment of the present disclosure.

FIG. 3G illustrates an exemplary method of steps for compounding of gift donations of the crowdgifting system participants arranged in a linear, binary, or matrixed tree arrangement, according to an embodiment of the present disclosure.

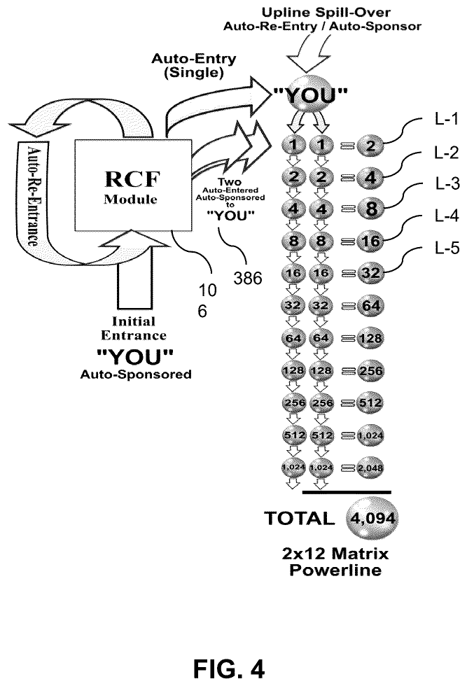

FIG. 4 illustrates auto re-entrance into the RCG module cycle after the completion of all levels of the RCG cycle, according to an embodiment of the present disclosure.

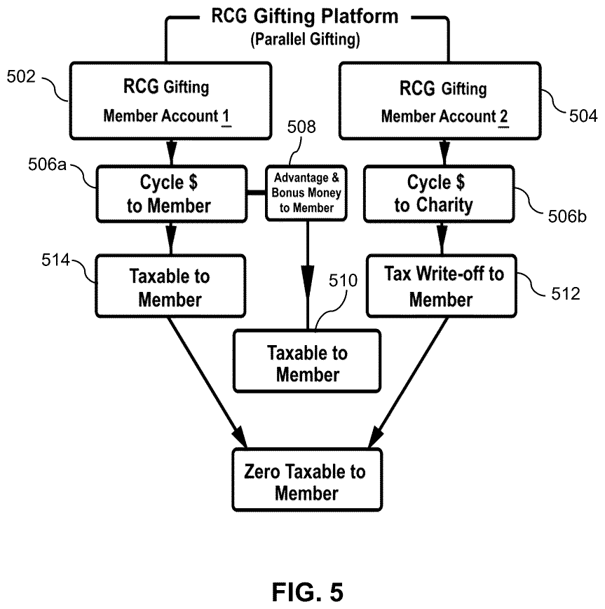

FIG. 5 illustrates a method of steps for generated wealth distribution in a parallel configuration, according to an embodiment of the present disclosure.

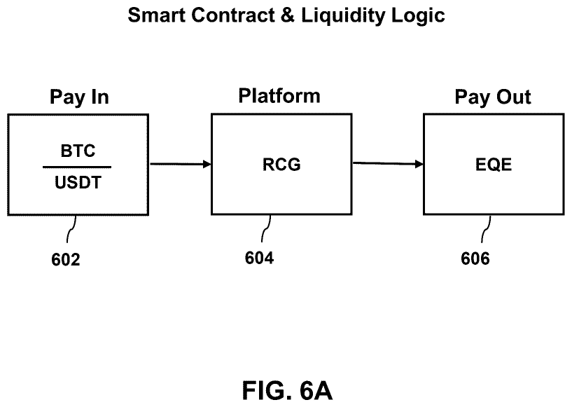

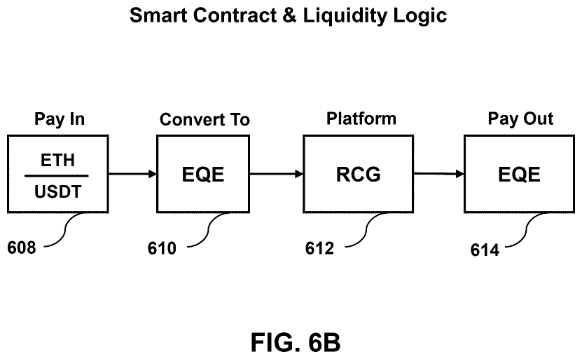

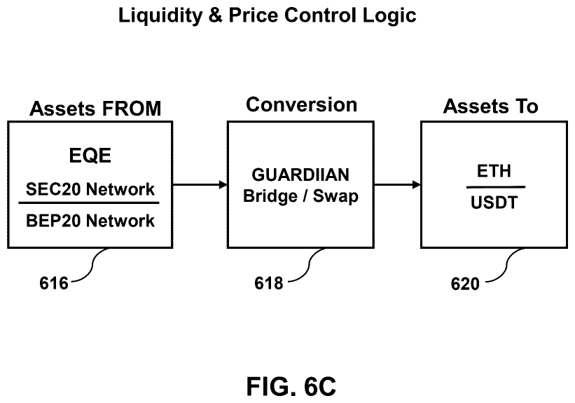

FIG. 6A illustrates a smart contract controlled liquidity generation and distribution method, according to an embodiment of the present disclosure.

FIG. 6B illustrates an exemplary smart contract controlled liquidity generation and distribution method, according to an embodiment of the present disclosure.

FIG. 6C illustrates a smart contract controlled priced value of a cryptocurrency and its method, according to an embodiment of the present disclosure.

### DETAILED DESCRIPTION OF THE INVENTION

The present invention sophisticatedly solves what has been long-standing problems compromising public cryptocurrency usage and stability; shortcomings with Crowdfunding; problems with financing Retirement and Insurance (of all types); problems with Social Commerce; as well as issues holding back Network Marketing by intelligently marrying some elements used in traditional Network or Multi-level Marketing with other technologies, such as Cryptocurrency and Crowdfunding, with Crowdfunding innovatively modified to be “reciprocating”, all contained within a specialized System to support the separate, several, and amalgamated whole of processes to achieve a balance and superior operational performance of each system severally and corporately.

Additionally, the present invention also significantly solves what has been a longstanding problem with Civil and Government proposed Universal Basic Income (UBI) systems; the primary problems of oppressive and limited resource taxation to generate system capitalization, and lack of a reliable system that has inherent systemic stability and accountability. Further, the present invention also significantly reduces the tax liability of the participants by duplicating through a system of “parallel gifting”, where the financial gains to a charitable organization offset the financial gains of the parallel income.

FIG. 1 illustrates a block diagram of a system of regulating and compounding of financial and commercial services in a reciprocating crowdgifting (RCG) system, according to an embodiment of the present disclosure. The system is implemented on a computing device including, but not limited to, a laptop, a smartphone, a PC, a server, etc. Further, the system includes a user admin management module 102 to provide access to and control of the various other System modules for participants in the RCG system. The user admin management module 102 may be accessed via an application installed on a user device, such as smartphone, laptop, tablet, desktop computer, etc.

Further, the system includes a communication module 104 to provide communication between the participants of the system. The participants are individual people, groups of people, or a binary/trinary/unilevel/matrixed crowdgifting system registered via the admin management module 102. The communication module may facilitate social media type communication, such as facebook, twitter—X, whatsapp, etc.

The system further includes a Reciprocating crowdgifting (RCG) module 106 to generate reciprocating crowdgifting among the participants of the system. The RCG module 106 receives a predefined amount of gift in the form of a financial instrument, such as fiat currency, cryptocurrency, vouchers, gift certificates, etc., from a new participant which will be donated to the upline participant in the system. The RCG module 106 may re-enter the existing participants to compound the gifts and ultimately financial services for the participants further creating a self-perpetuating crowdgifting system.

The system ability to Self-Regulate and Self-Perpetuate may be accomplished by the participant having “cycled”, now having to wait a certain and engineered period of time before re-entry, to assure that they do not “plug-up” or over-advantage themselves of the system, preventing others from entry or re-entry and ability to “cycle”. In other words, in this scenario, there is no instantaneous re-entry into the RCF Module 106 once the participant exits upon “cycling”. The participant may have to wait multiple “cycles” after it's “cycle” exit for the RCF Module 106 itself to “cycle” those participants who are in the RCF Module 106 at the same time, behind the subject participant, and the exact same number following into the RCF Module, before the subject participant is auto re-entered into the RCF Module 106, and so on.

Additionally, an example may be made that each time the subject participant exits the RCF Module 106 as a “cycle”, the system must wait the same number of “cycles” the subject participant “cycles” before auto re-entering the subject participant. For example, after the subject participant exits the RCF system as “cycle” one, its first “cycle”, it must wait two “cycles” before being auto re-entered into the RCF Module 106, and upon that second auto-re-entry “cycle”, must wait three subsequent system “cycles” before being auto-re-entered. Then after the participant third “cycle”, must wait four system “cycles” before being auto re-entered, and so on. Conceivably then, the subject participant could have to wait an eventual significant amount of time or “cycles” before it can be auto-re-entered, thus limiting the number of “cycles” any given participant may experience in any given period of time, which may conceivably provide a mechanism for a more equitable system distribution of participant and donation capital throughout the system, thereby assisting in the self-perpetuating aspect of the RCF system in particular.

The RCF module 106 may prevent the subject participant from auto-re-entry before the very last participant to enter, thus entering behind the very last participant and helping to finance the System and previous participants rather than continually being able to benefit from continually “cycling” before other participants may have an opportunity to “cycle” and gain from the system. There may be no conceivable way to know when the “very last” person as a participant enters or re-enters the RCF system, since there may be upwards of a billion or more people world-wide entering or re-entering the RCF system at any given time. Therefore, there may always be some form of inequality of “donation” distribution relating to auto re-entry, no matter how the auto re-entry is regulated and accomplished.

In an embodiment, the participant may have to wait 24 to 48 hours, or longer, or for a given number of “cycles” for any “donation” distribution to occur, until the System calculates the number of participants who have processed through the RCF Module 106 before “balancing” out the “donation” amounts to each and every participant within that period of time, so as to provide a fairer and more balanced outcome for all concerned. In another embodiment, the RCF module 106 may limit the amount of “donation” money any given participant may experience within any various period of time, thereby simplifying the equity and output quotient.

The system further includes the ability to have additional and series of ever-increasing levels or stages, whereby some of the “cycle” money can be applied from a previous stage to a subsequent higher gifting stage within the RCG module to advantage the System Participant (SP) with a more abundant amount of money, products or services. Such stages can be indefinite in number and amount of monetary output and gain for the SP, each subsequent stage being initiated automatically through an “auto-progression” algorithm. The subsequent higher stages are entered via the forwarding of some or all of the cycle money being applied or supplied by the previous lower-level stage into the next higher stage in such a way as to increasingly benefit and enrich the SPs without them having to provide any further out-of-pocket expense than their initial donation. This auto-progression feature results in the ability of all SPs to take advantage of higher levels of gifting/receiving than would otherwise be possible or attainable to those less financially capable to afford a significantly higher amount of initial monetary donation.

Further, the RCG module 106 may offer personal, direct sponsoring, and thus specific coding of a recruited or sponsored individual. Direct sponsoring may additionally be accomplished in a Binary or Matrix Module first, which again may have the lowest cost entry point and a one-time initial out-of-pocket expense. The RCG module 106 may automatically provide coding of the next available and non-coded participant entering for their first or initial re-entry time into the RCG Module 106 to the participant. In an embodiment, the RCG module 106 may accomplish crossline, multi-coding, and even multiple coding's to multiple participants without harm to Direct Sponsor downlines in non-RCG Modules, and can be utilized in a Network Marketing manner or in conjunction with outside Network Marketing companies.

Further, the system includes a cryptocurrency module 108 to provide the participants access to gifts and donations within the system. The cryptocurrency module 108 is implemented on blockchain network as to provide anonymous and decentralized mode of donating and receiving donations within the system. The cryptocurrency module 108 allows the participants to make payments and withdraw financial services in cryptocurrency.

The cryptocurrency module 108 performs a saving side and a monetizing side, although only the monetizing side is necessary. A Depository utilizes the reciprocating Crowdgifting system adapted for the purpose, or MLM model monthly purchase obligation and seeking to attain the similar Crowdgifting and/or MLM results of monetary generation, distribution and re-distribution. The Depository is a means whereby a participant may save money by having an in-System-specific Cryptocurrency deposited, i.e., a Cryptocurrency specific to and developed exclusively for the system. The reason for utilizing an in-system-specific cryptocurrency is to eliminate problems generally associated with Cryptocurrencies while advantaging by Blockchain technology.

A further reason to utilize a Depository is for the accumulation and compounding of System wealth to the benefit of all System Participants, (SPs). As the cryptocurrency is continually purchased and re-purchased every “Cycle” by SPs, the value of the cryptocurrency, in known manner, continually increases.

The System utilizes Cryptocurrency, Tokens, DeFi, and other Blockchain technologies to enhance and/or provide retirement savings through an Incentivized Sharing Depository that generates “interest” in the form of accumulating cryptocurrency cost and value as the in-System Cryptocurrency amount increases via mass involvement and contribution into the System by myriad System participants, through the automatic entry and re-entry (compelled purchase, re-purchase) methodology, matrix-based, or otherwise.

Blockchain is the technology that enables the existence of cryptocurrency, among other utilizations. A cryptocurrency is a type of “digital money” or currency that uses highly encrypted digital files as money that can be used to buy goods or services. It is a medium of exchange, such as the US dollar, but is entirely digital and uses encryption techniques to control the creation of monetary units and verify the transfer of funds.

Further, the cryptocurrency module 108 may utilize an in System-specific cryptocurrency is to eliminate problems generally associated with cryptocurrencies, such as to eliminate or significantly reduce value manipulation by outside forces that results in losses and volatility and create monetary stability. Another reason to utilize an in-System-specific cryptocurrency is to “flatten the curve” of foreseeable multiple world currencies being utilized to purchase into the Depository. Yet a further reason to utilize a cryptocurrency, whether internal or external to the System, is as a means to allow System participants to make money off the purchase of it as a Commerce Commodity through a Matrix algorithm similar to that which is used by Multi-level and Social Network Marketing. The cryptocurrency module 108 provides stability and utility to a generally unstable and consequently a considerably constricted use, mainstream cryptocurrency system, most specifically as it relates to a thoroughly accepted and commercialized exchange for goods and services.

The cryptocurrency module 108 may implement a dual currency to provide the System currency a controlled and systematic means of pass-through, passage or transfer outside of the System. The dual currency model may provide following advantages to the system:
1) devalue or debase the inter-System currency, but moderate its ever-increasing, ever-compounding attributes;
2) allow for the spending or transfer of the inter-System currency outside the (Eco) System under regulated circumstances;
3) circuitously provided support and stability by and between the ecto-System currency and inter-System currency to further increase the value and usability of both System currencies.

The inter-System cryptocurrency token system may be entirely matrix or RCG based, serving to continually increase and compound the currency. However, the System cryptocurrency, being bought, sold, and used outside the System, may undergo volatility and be subject to price manipulation.

The cryptocurrency module 108 may purchase system cryptocurrency bi-monthly to monthly producing a calculable increase of the value, offsetting any value volatility or price manipulation quotient that could or would cause market instability and usage insecurity by secondary or tertiary parties seeking to base product or services on cryptocurrency usage, which to this point has been relatively impossible due to the limitations and inherent shortcomings and resulting negative vicissitudes of public mainstream cryptocurrency.

The system further includes a vault module 110 and a bank module 112 connected to the cryptocurrency module 108. The vault module 110 is configured to store donations from the participants of the system in cryptocurrency. The vault module 110 may also operate as a stand-alone Crowdgifting entity, fueled or nourished by employing the system. Further, the bank module 112 allows the participants to do financial transactions and other Banking purposes. The vault module 110 and the bank module 112 are based on the blockchain similar to the cryptocurrency module 108.

The Banking module 112 works principally in tandem with the VAULT module 110 for the primary purpose of converting and enabling funds placed in the Depository to be later utilized by the System participant depositors within, throughout, and potentially outside of the System. One purpose for an internalized Banking system is to provide readily attainable loans against Depository accounts that would thereby be collateralized loans. The reason for this collateralization is in an effort to maintain as much Cryptocurrency money in the Depository as possible at all times for the purpose of increasing wealth for all participating in the Depository retirement and wealth generating/saving system. If too much Cryptocurrency were removed at any given time or over any length of time, the value of the System Cryptocurrency would diminish. To prevent any serious diminishing of the Cryptocurrency value as would involve significant withdrawals relating to potentially large purchases such as homes, properties, jewelry, boats, etc., especially if a great many individuals wanted to make large withdrawals at the same time, the safeguard to maintaining the Cryptocurrency value would be accomplished through collateralized loans. The collateralization would be accomplished through withholding of a percentage of Cycle payouts to repay the loan over time.

An internal Banking system can additionally and more readily provide mortgage and other loans utilizing Depository funds as collateral, further providing that the System is self-contained and regulated, and therefore not subject to outside manipulating forces that may potentially adversely affect and degenerate the System in part or in whole. An internal Banking module 112 may further ensure that holistic continuity is maintained throughout the System, enabling participants to more readily and easily utilize various System aspects to their advantage, more synergistically and holistically.

In addition to the afore described typical functions of a Bank module 112 and vault module 110 described here, function as a form of residual income mechanism, monetizing these formerly and historically non-monetized Banking and Depository Savings functionalities, through either a Binary, Trinary, Matrix, or other such algorithmic mechanism and regulated by smart contracts.

Further, the system includes commerce modules 114, standard commerce, and 116, matrixed commerce, which allow external merchants and stores to offer their services, goods, products, coupons, etc. In an embodiment, the commerce modules relate to an existing Retail, Service, Multi-level Marketing (MLM) or Direct Marketing company and its products, showing how such an existing company may be integrated into the organic “Flow” system or how such an existing company may integrate the System unto itself.

The commerce malls 114, 116 provides a single access point portal to a single or multiple outside retail products distributing business such as for example, Amazon.com, Walmart, or any other retail product distribution entities. The same Multi-level Marketing or Social Network Marketing principle of a monthly financial commitment may still apply since the matrix application would be used in any event, with purchase percentages distributed throughout through any varied means.

FIG. 2 illustrates a flowchart of a process 200, of regulating compounding of financial services in a crowdgifting system, according to an embodiment of the present disclosure. The steps of the process 200 are performed by a participant on the system of FIG. 1. The process 200 is a novel form of Crowdgifting which is reciprocating, meaning participants share in both “donating” and being “donated to” through the known monetary mechanism of Crowdfunding, which in this case is modified to be reciprocating through an as known a 2×2 or other such binary or matrix methodology utilized principally in Multi-level and Social Network Marketing. In this RCG system, the donator(s) or giver(s) alternately become the donatee(s) or recipient(s), while the donatee(s) alternately become the donator(s), all taking place concurrently and synchronously. This provides exceptional incentive for individuals to “donate” or “gift”, which may be an incentive that is lacking in typical Crowdfunding and holds it back. The donations in this case are monetary but can also be goods and services.

At step 202, a participant qualifies themselves to participate in the system by providing personal information such as banking, email address, etc., in known manner, and typical to any Crowdfunding or Multi-level marketing platform. The participant then donates a specified amount of money or gift into the RCG system, which is automatically donated by the automated system to the an upline participant who preceded the SP participant into the system. The next participant following a previous participant into the RCG System likewise qualifies themselves and donates, with all subsequent individuals entering into the RCG system doing the exact same. This produces a single line of individuals processing through the RCG system through the RCG module 106, as illustrated in FIGS. 3A and 3B.

At step 204, the participants are added to the existing RCG system by performing the step 202 iteratively. A cycle is formed when the plurality of participants are added to the RCG system. The cycle ends when the existing participant completes the requisite number of gifting/receiving processes. At step 206, the gross collection of the cycle is determined and communicated to each participant of the RCG system via the communication module 104.

At step 208, the single line of participants of the cycle may automatically re-enter the RCG system via the RCG module 106, paying a fee or providing a donation from money received in the cycle, thereby avoiding any out-of-pocket expense and enabling the System to self-perpetuate, indefinitely, adding systemically unique features to the RCG system individually and the entirety of the system itself. The reasons for re-entrance are further described herein, but the primary reason is for a participant to attain more money, goods or services, as well as sustain and substantiate the system.

At step 210 and 212, the system monetizing and money generating “Modules” can relate to various commerce or service providers, such as are used in known manner in typical mainstream Multi-level and Network Marketing, also known as “Direct” Marketing. These include, but are not limited to, utilities, food, clothing, health and wellness related products, pet products, insurance of various kinds, pre-paid legal services, cryptocurrency, commodities such as gold and silver, and lottery and sweepstakes related offerings to name but a few. In the case of the Invention, all of the above and more are to be considered within the scope of the invention's capability and intent.

At step 214, 216, and 218, the system eliminates outside influence and price manipulation entirely. The cryptocurrency may only be purchased within the self-regulating System. The Depository and inter-System cryptocurrency overcome the potential problem of cryptocurrency failure due to it being a self-contained currency within the System. The vault module 110 provides smart contract driven rules and regulations for the cryptocurrency distribution, its retention within the Depository, its extraction, its predominant usage within the System, and its conversion to other forms of currency to ensure stability and perpetual increase of value, the primary nucleus for its usage being in one manner a form of retirement security.

A primary functionality and feature of the “RCG” Module 106 is its inherent ability to be self-perpetuating, a function which guarantees the “feeding” of the other Modules by this primary Module. By “feeding” is meant the population of the other Modules of people and monetary resources to benefit those persons, either directly or indirectly, via the Binary, Trinary, Unilevel, or any varied form of Matrix algorithms.

FIG. 3A illustrates a flow diagram of one possible form of the distribution of monetary donation(s) using a reciprocating crowdgifting (RCG) module and FIG. 3B illustrates the matrix flow diagram of L-1 thru L-5 sections of FIG. 3A in different manner for purpose of clarity, according to an embodiment of the present disclosure. In an exemplary embodiment, the initial person “You” 302 starts their individual Crowdgifting process by making a monetary donation into the System, directly or indirectly donated or gifted, to the person who directly preceded “You” 302 into the system. The platform smart contract or programming automatically accounts for and provides for this, as well as providing for the “coding” of “You” to the person who directly preceded “You” into the System (“U-1”) 304. “You” may then optionally send “invitations” to others via the RCG system, other online means, or other means. When the Invitation Recipients (IRs) or others subsequently sign up and donate to “You” 302, “You” receive two of the donations L1 314. Optionally, the “You” 302 secures other individual(s) to sign-up, and the System or other individual(s) likewise obtain sign-ups, or Word of Mouth (WOM) otherwise populates the System, the process systematically continues in a relatively linear and exponential fashion. The system may continue in a relatively indefinite and circuitous fashion if a re-entry element is added to the equation. It may also have a re-entry limit as the IR must start all over again after L-5 322 through any varied re-entry process.

In an embodiment, applying a Multi-level Marketing methodology to the above system seamlessly enables a growing network of individuals to share in the Crowdgifting experience or monetary enrichment via known multi-level methods such as the preferred method of a Matrix, or a Binary, Trinary, unilevel, or other known MLM pay-out methodology. Other known multi-level compensation methods are Unilevel, Forced Matrix, and Breakaway Plans that can be utilized in this Incentivized Sharing Crowdgifting Platform. However, the preferred method for the RCG Module is the simple linear method resulting in a 2×2, 2×3 or (or higher) level matrix as shown in FIGS. 3A, 3B, 3C, 3D (equivalent), and FIG. 4.

In another exemplary embodiment, after “You” 302 sign up, “You”, as a new System Participant (SP), contribute, gift, or donate an initial donation 324, in this case $10, and the system does virtually everything else for you and other subsequent SPs; in fact, neither you nor the other subsequent SPs may ever have to experience another out-of-pocket expense. The SPs only real involvement is when it comes to the SP choosing whatever products the SP wants to receive. You, the SP, easily specify those and can change them so that you and other SPs don't get over-saturated with any one product or service. Further, as other SPs initiate campaigns and enter the RCG Module 106 behind you, propelling you through, you complete the Module, which is called a “Cycle” 326a. Further, an amount of donation received may also be supplied into the system as a system fee 326b and/or underwriting fee 326c to maintain and secure further operation of the RCG system.

FIG. 3C illustrates a linear description of the FIG. 3B flow diagram of distribution of gifts using a reciprocating crowdgifting (RCG) module 106, relating partially to the “L” designations of FIG. 3A indicated by “L-1 (of Y)” and “L-1 (of X)” which can then be extrapolated therefrom, according to an embodiment of the present disclosure. In an exemplary embodiment, Y 302 donates to the Z1 328 upline U-1. The Y 302 also receives the donations from the downline X1 and X2 330, X1 further has downline X3 and X4 332 from which X1 330 receives donations. The RCG system may include a plurality of linear versions making it a self-perpetuating and self-sustaining crowdgifting system.

FIG. 3D illustrates a uniquely different version of a linear distribution of gifts using a reciprocating crowdgifting (RCG) module 106, according to an embodiment of the present disclosure, shown in a tubular arrangement that quasi-represents the varying levels of L-1 thru L-5. In this scenario, the “You” (Y) or #1 302 directly receives donation from the entire line of SPs entering into the gifting stream behind Y 334. The donation amounts received correspond to the equivalent of L-1, L-2, L-3, L-4, and L-5 levels. Furthermore, as depicted, each level equivalent of L-2 thru L-5 can result in the completion of a Cycle, with each progressive L level resulting in a cycle producing and delivering a larger amount of money to the recipient SP. In other words, if L-2 results in a Cycle, L-3 thru L-5 are not employed; if L-3 is the culmination Cycle, then L-4 and L-5 are not employed. After the Y, #1, 302 SP Cycles, the #2 SP in 334 receives the donations from the entire line of SPs entering into the gifting stream behind the last SP in 334 as shown in the encapsulation illustration of 336, L-2 (4), L-3 (8), L-4 (16), L-5 (32). Successively, the #3 in 334 receives the donations from the entire line of SPs entering into the gifting stream behind the last SP in 336. Again, successively, the #4 in 334 then receives the donations from the entire line of SPs entering into the gifting stream behind the last SP in 338. This distribution of donations continues in similar fashion throughout the remaining SPs #'s 5 thru 32 in 334, and so on throughout the gifting/receiving process.

When auto-entry and auto-re-entry are employed, the “You” (Y), or #1 302, can be inserted into the incoming stream of gifting SPs after 334, anywhere in sections L-2, L-3, L-4, or L-5 in 336 or afterwards, once again donating $10 of the proceeds money Y received in 334, thereby requiring no more out-of-pocket expense.

FIG. 3E illustrates an exemplary method of steps for compounding of gift donations of the crowdgifting system participants arranged in a linear, binary, or matrixed tree arrangement, according to an embodiment of the present disclosure. The RCG module 106 facilitates auto-progression 340, from one donation gifting stage to another. When auto-progression is employed, the amount of donation compounding is increased by adding upward stages and utilizing the donation money received by SPs to increase the amount of money they receive and donate. This method results in faster Cycles with reduced number of downline SPs required to produce the same amount of money, and again happens without SPs having to expend any out-of-pocket money than their initial $10. Three separate “Stages” (Stage 1, Stage 2, and Stage 3) are shown in FIG. 3E although more Stages may be added to increase the compounding effect and monetary output, such as a Stage 4 and subsequent Stages. Each of the various Stages compounds the monetary benefits in and of themselves, and produce additional compounding when used sequentially. Additionally, each Stage can be programmed to Cycle only once so that there are only two Cycles per Stage, once to provide the payout capital for qualified auto-progression into the successive Stage, and once to provide payout to the SP through a single auto-reentry 208. Further, each Stage can be programmed to Cycle independently of each other Stage, so that SPs Cycle more in one Stage than another. The System can also be programmed so that SPs Cycle in all Stages simultaneously and continually, with Cycles being limited to once, twice, or more, an hour, day, month, or year, or even unlimited.

FIGS. 3F and 3G illustrate method steps of “Coding” of gifts and SPs of the crowdgifting system participants arranged in a linear, binary, or matrixed tree arrangement, according to an embodiment of the present disclosure. The System may provide Coding of Invitation Recipient (IR) recruited individuals to provide a permanent connection of the recruited IR to the recruiting IR, for the benefit of both. FIG. 3F relates specifically to a Single Pass-through-Single Sponsoring or Coding, Auto Sponsored/Coding (AS/C). FIG. 3G relates specifically to a Single Pass-through-Double Sponsoring or Coding arrangement, Auto Sponsored/Coding (AS/C-1, AS/C-2) groupings 384 as encapsulated in dotted line. The Coding ensure that the Invitation Provider (IP) and IR are organically and automatically connected throughout the system.

The RCG module 106 then automatically Codes or permanently affixes “You” 380 to the upline “U-1” 382 individual. The “U-1” 382 individual then technically becomes the “Sponsor” of the “You” 380 individual for the subsequent progression.

The RCG Module 106 may be used in lieu of a standard Matrix type system, there is then no need for this type of Coding. Additionally, when the further described “Matrix within a Matrix” methodology is used, solely employing the RCG Module 106, a more dynamic quasi-Matrix action is possible, allowing for a more fluid, dynamic, and far less rigid positioning of SPs within the Matrix, thus providing for a far more balanced System distribution outcome and dynamic process than all known MLM type methodologies.

FIG. 4 illustrates auto re-entrance into the RCG module cycle after the completion of all levels of the RCG cycle, according to an embodiment of the present disclosure. FIG. 4 shows the RCG system circuitously feeding “cycled” SPs into a 2×11 (or more, or less) standard Matrix configuration. The RCG module 106 circuitously feeding uniquely into a 2×‘X’ Matrix type system comprised of RCG matrixed, binary, trinary, unilevel, or other similar methodology Modules, an entirely unique dynamic that produces a continuous, circuitous, compounding, self-perpetuating generation of gifted/donated money, goods, and services for the System Participants (SPs). The compounding nature of the Reciprocating Crowdgifting model especially allows for a compounding Matrix within Matrix model.

For participation in the subsequent “Single Initial Purchase” matrix or binary (a single direct out-of-pocket purchase coming either from the individual directly or through the automated RCG System process), the participant may automatically be provided with one or two Auto-Sponsored individuals who subsequently followed after them into the RCG system, thereby qualifying them for earnings as shown in FIG. 3E as “AS/C”, (Auto-Sponsored/Coded) and FIG. 3F as (2) “AS/C”, and their participation in any other given Module is paid for by a certain percentage of proceeds from the previous RCG Module 106. This cohesive and organic flow from one Module into another assures the highest potential monetary and sales return for participating companies which utilize the System and the individuals who participate in it.

When the RCG module 106 is utilized in conjunction with this holistic and synergistic modular system configuration, the RCG “jumpstarts” individual participation into the Multi-level Marketing industry, painlessly, seamlessly, almost effortlessly. The potential to increase the MLM industry size is virtually incalculable, but most certainly the increase could be by many multiples.

By automatic enrollment, the System becomes further self-propagating, further reducing or eliminating the need for “recruiting” by Sponsors to more costly, more involved, or more advanced Modules of the System. This gentle and organic system of automatic enrollment from one platform Module to the next produces a gradual and graduated involvement, additionally reducing the need to overload participants with complicated training and/or overburdening the MLM IR recruiting Distributors.

FIG. 5 illustrates method steps of generated wealth distribution in a parallel configuration, according to an embodiment of the present disclosure. The actual capitalization tax and money credited to the individual SPs originates from the RCG Module 106 which populates and feeds the Binary, Matrix, Unilevel, or other such mechanisms. The system may duplicate the money credited to a charitable account to reduce the tax liability of the participants. Further, the system may generate a code to connect the RCG system to the chartable account. The code may be a 12 digit alpha numeric or similar combinations code unique to each participant of the system. Further, the system may duplicate the financial services, such as money credited or other donations of the RCG system to the chartable account.

FIG. 5 depicts a flowchart method steps of generated wealth distribution in a parallel configuration. At step 502, the method includes generating a code for connecting the charitable account (member account 2) to the RCG system (member account 1). At step 504, the charitable account is connected to the RCG system, and each donation and capital gain is duplicated to the charitable account. At step 506, each cycle of RCG system is iterated and the donations are duplicated to the charitable account. At steps 508 and 510, the advantages or bonuses availed to the participant are taxed as per participants' tax bracket because they are an additional source of revenue stream that is not associated with the 504 account 2. Further, at step 506a and corresponding step 506b, the monetary or other gifts duplicated in the charitable account 506b subsequently result in a write-off for the participant 506a gifts received. The monetary of other gift types availed to the participant also become not taxable. Thereby saving substantial taxes for the participant in the RCG system. Furthermore, the RCG can be used in like manner without the need for a parallel configuration, whereby a charitable account 504 is employed to offset any taxable income made outside of the RCG gifting system.

FIG. 6A illustrates a smart contract-controlled liquidity generation and distribution method, according to an embodiment of the present disclosure. FIG. 6A shows established and liquidity rich cryptocurrency being used to onboard into the RCG module 106, shown here as 604 of the three-part sequence. Once the RCG “cycle” is completed, the donation/gift money is provided to the Member in the native EQE token as an end result in 606. This process injects liquidity into the EQE stablecoin by virtue of the RCG mechanism, providing ample, reliable, and continuous infusion of liquidity, without the need and burden of backing the EQE stablecoin with a fiat currency. This method additionally eliminates the need for continual and costly stablecoin audits that assure a 1:1 ratio with the asset or fiat currency the token is tied or tethered to.

At step 602, the method includes using established and liquidity-rich cryptocurrencies, in this example BTC (Bitcoin) and USDT (Tether). These cryptocurrencies are selected due to either their stable nature and/or significant liquidity in the market. Users onboard into the RCG system using these cryptocurrencies as the initial step. The rationale behind using BNB and USDT is to ensure a stable or at least reliably liquid source of value entering the system. These coins are well-established in the market, providing a predictable and secure foundation for the subsequent steps.

At step 604, the RCG module 106 implements core logic and processes including the flow and transformation of the input cryptocurrencies. The RCG module 106, shown in 604, operates a cycle that facilitates the gifting and receiving mechanism. During this cycle, the deposited BTC or USDT is processed within the system. The exact nature of this cycle involves complex smart contract interactions and liquidity management strategies that ensure the stable and continuous operation of the system.

The platform's role is crucial in transforming the input value (BTC/USDT) into a format that can be used for the final payout. It ensures that the process is transparent, efficient, and aligned with the system's liquidity logic.

At step 606, the method includes providing payout to the members, represented by the EQE token. Upon completing the RCG cycle, the system provides the donation or gift money, or vouchers for products and services, to the members in the form of the native EQE token, or vouchers backed by the EQE token.

FIG. 6B illustrates an exemplary smart contract-controlled liquidity generation and distribution method, according to an embodiment of the present disclosure. FIG. 6B shows established and liquidity rich cryptocurrency being used to onboard into the RCG module 106 differing in method from FIG. 6A. In this method, FIG. 6B involves the converting of established and liquidity rich cryptocurrency into the System native EQE stablecoin prior to the currency entering into the Gifting/Donating process of the RCG, resulting in a continuously stable value within the RCG that is controlled by the EQE stablecoin algorithm.

At step 608, the method in this example includes using established and liquidity-rich cryptocurrencies ETH (Ethereum) and USDT (Tether), similar in manner of the description of FIG. 6A. At step 610, the method includes converting ETH or USDT into the system's native EQE stablecoin before entering the platform. This conversion step is crucial for maintaining the stability and controlled value of the funds as they move through the system. By converting the input cryptocurrencies into EQE prior to the currencies entering into the 612 step, the system leverages the stability algorithm of the EQE stablecoin, ensuring that the value remains consistent and predictable. This approach minimizes the risks associated with the volatility of non-stablecoins and governance tokens, which can fluctuate significantly in value.

At step 612, the RCG module 106 implements core logic and processes, managing the flow and transformation of the converted EQE stablecoin. The RCG module 106 operates a cycle that facilitates the gifting and receiving mechanism. During this cycle, the EQE stablecoin is processed within the system. At step 614, the method includes providing payout to the members, represented by the EQE token. Upon completing the RCG cycle, the system provides for all of the results similar to 606 in FIG. 6A.

FIG. 6C illustrates a smart contract controlled priced value of a cryptocurrency and its method, according to an embodiment of the present disclosure. The native token EQE is Bridged into any other various coin or token. The Bridge assures that the native EQE stablecoin remains 1:1 with its value control assets, such as the US Dollar or Euro. The Bridge also controls value in the opposite direction, or reverse order, from an established cryptocurrency, such as USDT or BNB, through the Bridge, into the EQE token.

At step 616, the method involves the native EQE token, which is network based within the SEC20 SCAI Network and the BEP20 Binance Network. This stage represents the initial point where EQE tokens are sourced from the network for conversion. EQE tokens are utilized within the system to facilitate various transactions and processes, ensuring a stable and predictable value within the ecosystem.

At step 618, the method includes performing conversion process facilitated by the Guardian Bridge. This bridge plays a crucial role in maintaining the stability and value control of the EQE token. The Guardian Bridge ensures that the EQE stablecoin remains pegged 1:1 with its control assets, including fiat currencies such as the US Dollar or Euro. This pegging mechanism is essential for maintaining the stable value of EQE, preventing fluctuations that could arise from market volatility.

Additionally, the bridge controls the value in the opposite direction as well. It enables the conversion of established cryptocurrencies like USDT (Tether) and BNB (Binance Coin) back into the EQE token, ensuring a seamless and controlled flow of value both into and out of the EQE ecosystem.

At step 620, the method includes representing the conversion of EQE tokens into other established cryptocurrencies, such as ETH and USDT. This stage ensures that users can convert their EQE holdings into widely recognized and liquid cryptocurrencies.

By allowing the conversion to established cryptocurrencies, the system provides flexibility and liquidity to the users. It ensures that EQE token holders can seamlessly convert their tokens into other forms of digital assets, facilitating broader use and acceptance.

What is claimed is:

1. A system for a regulating and compounding of financial and commercial products and services through a reciprocating crowdgifting (RCG) system, wherein the system comprises of a single or multiple reciprocating gifting or donating matrix, a binary, a trinary, a unilevel, a linear constructed matrix, or any combination thereof,
wherein the system is comprised of a reciprocating crowdgifting system (RCG) which is configured to circuitously feed into at least a 2×2 matrix type system comprised of at least a RCG matrixed, binary, trinary, unilevel, linear constructed matrix, or any combination thereof, and wherein the RCG system is configured to be an initiating and a self-perpetuating system, and
wherein the RCG system is used to insure and underwrite within itself or outside itself, and
wherein the RCG system is an automated system which is configured to automatically code at least one succeeding individual user to at least one preceding upline individual making the upline individual a potential sponsor of the succeeding individual.

2. The system of claim 1, wherein the crowdgifting is comprised of separate or various combinations of money, goods, or services acquisition and distribution through reciprocal transactions between donators and donatees.

3. The system of claim 1, wherein the RCG crowdgifting-based matrix, binary, trinary, unilevel, or linear constructed matrix, or any combination thereof, is comprised of one or more RCG system(s) contained within one or more other RCG system(s).

4. The system of claim 1 being configured to propagate social networking, multi-level or direct marketing companies, with or without the need for sponsoring or sponsoring requirements or the need for any purchase requirements to qualify for monetary or other reward.

5. The system of claim 1 being configured to benefit sales within the system and outside of the system.

6. The system of claim 3 being configured to produce and promote a compounding effect upon the system currency, products and services; to produce systemic self-sustaining and self-perpetuation.

7. A system of claim 1 being utilized for a universal basic income (UBI) Banking system comprising a reciprocating crowdfunding matrix, binary, trinary, unilevel, linear constructed matrix, or any combination thereof, partially or fully contained within a self-supporting eco system.

8. The system of claim 7, wherein the banking system comprises the provisioning for external currencies and commodities to enter into the banking system; which partially or entirely does not permit the associated wealth to exit the eco system for the purpose of enriching, perpetuating, and stabilizing the banking and eco system.

9. A system for a universal basic income (UBI) currency or cryptocurrency being based on at least a matrix, binary, trinary, unilevel, linear constructed matrix, or any combination thereof, with or without being eco system dependent.

10. The system of claim 3 or 9, wherein the currency system provisions for compounding via a matrix, binary, trinary, unilevel, or linearly constructed method of reciprocating crowdgifting.

11. The system of claim 6, comprising a compounding effect upon the system currency being utilized to provision bank loans; bank loans which can be of a predetermined-interest rate.

12. A method of regulating and compounding of financial and commercial products and services through a reciprocating crowdgifting (RCG) system, the method comprising:
collecting a predefined amount of gift from new participant of the RCG system, wherein the RCG system is managed by a reciprocating crowdgifting (RCG) module;
generating compounding effect of the financial services by providing provisions for re-entry of the existing participants in the RCG system;
providing provisions to avail the financial services on the basis of contributed gift by the participant, wherein the financial services are availed through a fiat or inter-system cryptocurrency; and
duplicating the financial services in a parallel RCG charitable account to reduce the tax liability of the participants.

13. The method of claim 12, wherein the RCG charitable account is not parallel but acts independently to reduce tax liability of the participants.

14. The method of claim 12, wherein the collected gift from the new participant is transferred to a participant upline in the RCG system.

15. The method of claim 12, wherein the RCG module is configured to create a self-perpetuating RCG system comprising a matrix, binary, trinary, unilevel, linear constructed crowdgifting system, or any combination thereof, within the RCG system.

16. The method of claim 12, further comprising:
compounding the gift by re-entering the binary, trinary, unilevel, linear constructed crowdgifting system, or any combination thereof, within the RCG system.

17. The method of claim 12, wherein the financial services are based on a blockchain.

18. The method of claim 12, wherein the financial services comprises coupons, cash, loan, products, and services.

19. The method of claim 12, further comprising the RCG system within the RCG system, or a series of Crowdgifting systems within the RCG system or within a series of the RCG systems.

20. The method of claim 12, further comprising:
utilizing a dual inter-system and ecto-system Cryptocurrency, Token, or other such DeFi mechanism whereby the ecto-system mechanism secures and stabilizes the inter-system cryptocurrency.

21. The method of claim 20, wherein the dual inter-system and ecto-system Cryptocurrency, Token, or other such DeFi, are comprised of utilizing a RCG system matrix methodology, separately, concomitantly, or circuitously.

22. The method of claim 12, further comprising:
distributing financial services comprising a Matrix within a Matrix or series of Matrixes within the RCG system, wherein the matrix is a binary, trinary, unilevel, linear constructed matrix, or any combination thereof, of participants mapped to an existing participant.

23. The method of claim 12, further comprising:
capitalizing or underwriting the distributed financial services to provision the securing of loans, property or medical Insurance for the participants.

24. The method of claim 12, further comprising:
a method of connecting the RCG system to the charitable account; and duplicating the financial services of the RCG system to the charitable account.

25. The method of claim 12, further comprising:
the utilization of the RCG system as an entirely charitable system; and thereby providing tax write-off benefits to participants.
